(19) United States
(12) Patent Application Publication
(10) Pub. No.: US 2008/0035258 A1
(43) Pub. Date: Feb. 14, 2008

(54) Attachable Tire Traction System

(76) Inventor: Ahmet Koc, Istanbul (TR)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/578,484

(22) PCT Filed: Apr. 8, 2005
(86) PCT No.: PCT/TR05/00017

§ 371 Date: Feb. 5, 2007

(30) Foreign Application Priority Data
Apr. 14, 2004 (TR) 2004/00784

(51) Int. Cl. B60C 27/06

(52) U.S. Cl. 152/213 R

(57) ABSTRACT

Tire track system (A) of the invention comprising attachable tire tracks (1), inner metal tracks (2), rigidified pins (3), track locking pins (4), front stretcher hooks (5), rear stretcher hooks (6), lock piece of rear stretcher (7), jamming capsules of steel rope (8), a steel rope of rear stretcher (9) a steel rope covering of rear stretcher (10) and a front stretcher rubber (11) is provided. The system of the invention is capable to be attached or covered to the vehicle tires and it is operative in all winter conditions, inexpensive, easy to attach/detach and protective for vehicle tires in contrast to chains which have a breaking off problem, harm to vehicle tires, front equipments such as vehicle axle, ball bearings or other equipments due to vibration or impacts.

### TECHNICAL FIELD

This invention relates to a system which facilitates driving of the vehicles on the surfaces with snow and ice by being attached to the outer surface of the vehicle tires.

### BACKGROUND ART

Various methods have been used in order to facilitate driving of vehicles on snowy and icy surfaces during winter conditions. One of these methods, namely studded snow tires, has not been widely used due to their costs. Although, studded snow tires are suitable for being used especially on icy roads, they could not be used where the snow thickness is huge. Instead, chains which wraparound the vehicle tires are preferred. As for chains, they lead to difficulties of attachment-detachment necessities upon varying road conditions. Moreover, they cause malfunctioning of some parts of the vehicles due to generation of vibrations.

In the prior art, different solutions have been made to problems mentioned above to enable vehicle tires suitable for winter conditions by covering the tires. Particularly, in patent/patent applications: DE3506649, DE3506650, DE3616372, ES2013405, FR2537060, GB1238637, GB190921111, GB2049575, polymer and metal tracks covered to the outer surface of the vehicle tires have been described. Since, there are difficulties for covering these tracks on the tires and their structures being complex, many problems occur concerning with the cost, utilization and maintenance thereof.

### OBJECT OF THE INVENTION

The object of the invention is to provide a tire track system being attached or covered on the vehicle tires, usable in all winter conditions, inexpensive, easy to attach/detach and protective for tires.

### DESCRIPTION OF THE DRAWINGS

The system of the invention is illustrated in the appended figures, in which:

FIG. 1. is a perspective view of the attachable tire track system and its parts before mounting on the vehicle tire.

FIG. 2. is a perspective view of the attachable tire track system and its parts after mounting on the vehicle tire.

FIG. 3. is a rear view of the attachable tire track system and its parts after mounting on the vehicle tire.

FIG. 4. is a front view of the attachable tire track system and its parts after mounting on the vehicle tire.

In figures, each part is numbered individually and corresponds to the numbers given below:
A. Attachable tire track system
B. Vehicle tire
C. Rim cover
1. Attachable tire track
2. Inner metal track
3. Rigidified pin
4. Track locking pin
5. Front stretcher hook
6. Rear stretcher hook
7. Lock piece of rear stretcher
8. Jamming capsule of steel rope
9. Steel rope of rear stretcher
10. Steel rope covering of rear stretcher
11. Front stretcher rubber
12. Outer surface of tire track
13. Pin holes of tire track
14. Stretcher loops of tire track
15. Connection tabs of tire track
16. Pin holes of inner metal track
17. Connection tabs of inner metal track

The subject of the invention is a tire track system being attached or covered vehicle tires, usable in all winter conditions, inexpensive, easy to attach/detach and protective for vehicle tires. The most important properties of the attachable tire track system are being an alternative to chains which have a breaking off problem, harm to vehicle tires, front equipments such as vehicle axle, ball bearings or other equipments due to vibration or impacts, being free of rupture problems as in the case of chains, protective for vehicle tires, usable on the roads even there is no snow/ice, non-harmful to any equipment of the vehicle, operative relatively quiet comparing to chained tires. In addition, attachable tire tack system has capability to be attached/detached easily and these operations could be done without removing the tire or lifting the vehicle.

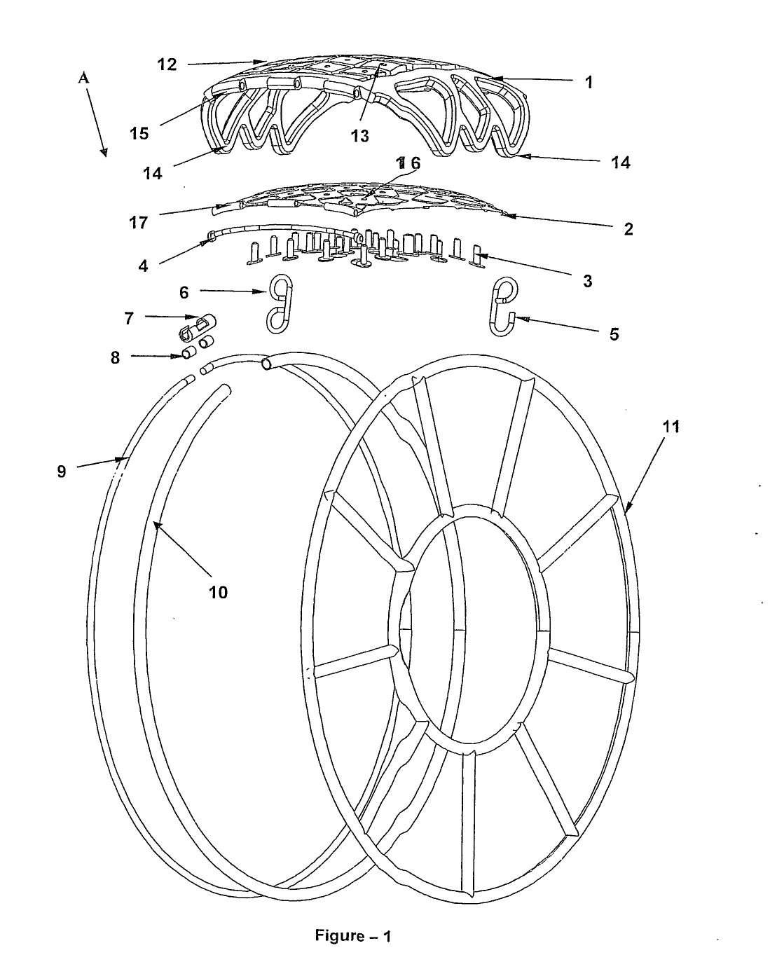

As shown in FIG. 1, attachable tire track system (A) of the invention comprises attachable tire tracks (1), inner metal tracks (2), rigidified pins (3), track locking pins (4), front stretcher hooks (5), rear stretcher hooks (6), lock piece of rear stretcher (7), jamming capsules of steel rope (8), a steel rope of rear stretcher (9), a steel rope covering of rear stretcher (10) and a front stretcher rubber (11).

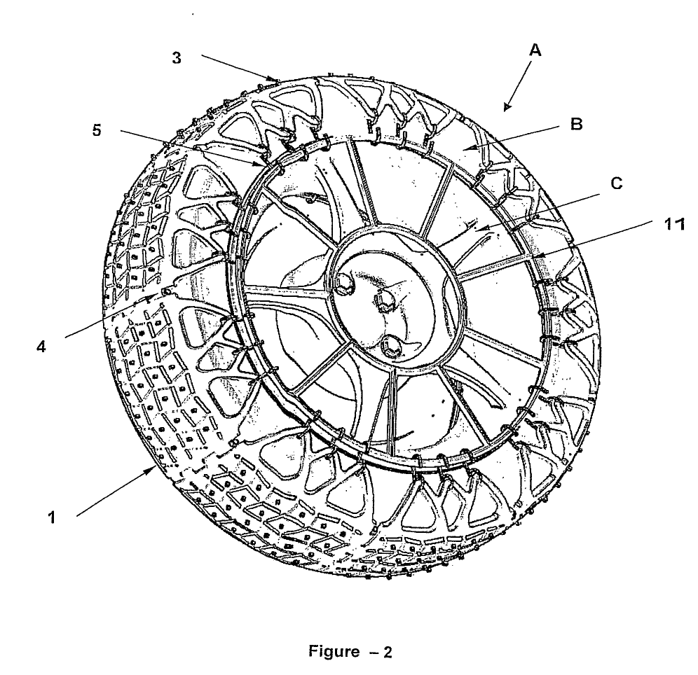

Attachable tire tracks (1) have outer surfaces (12) of tire track which is grooved and diked similar to the patterns of vehicle tires (B) (shown in FIGS. 2, 3 and 4), pin holes (13) of tire track through which rigidified pins (3) can be fitted, and are in the form of a band. Stretcher hooks (14) of tire track are formed at the opposite ends of the band form matching to the lateral surface of the vehicle track (B) at which the front and rear stretcher hooks (5, 6) are attached. Perforated connection tabs (15) of tire track are placed at the other both ends of the band form to connect the attachable tire tracks (1) together. Attachable tire tracks (1) are preferably made of rubber material which is more elastic than that of the vehicle tire (B). Attachable t ire tracks are manufactured by molding in one piece. When attachable tire tracks (1) are joined together by the connection tabs (15) of tire track, resulting structure in the form of a long band is wrapped to the contact surface of the vehicle tire (B) to the ground and takes the loop form by being joined at this surface. Attachable tire tracks (1) wrapped to the vehicle tires are used as one or more, preferably 9 pieces, in the context of the invention.

Inner metal tracks (2) placed under the attachable tire tracks (1) have pin hole of inner metal tracks through which the rigidified pin (3) can be fitted. Inner metal tracks (2) lay between the attachable tire tracks (1) and vehicle tire (B). Pin holes (16) of the inner metal tracks retain the rigidified pins (3) in place without being disrupted. Further, inner metal track (2) has the form of a band to be placed under the attachable tire tracks (1). Perforated connection tabs (17) of inner metal track are placed at both sides of the band form to connect the inner metal tracks (2) together. Rigidified pins (3) fitted through the pin holes (16) of the inner metal track and the pin holes (13) of the attachable tire track hold together the attachable tire track (1) and the inner metal track (2) just beneath hereof. Consequently, the strength of the attachable tire tracks (1) reinforced with the inner metal track (2) is improved and as a result tearing is prevented. Inner metal tracks (2) are joined together by the connection tabs (17) of the inner metal track. Inner metal tracks (2) are used as one or more, preferably 9 pieces, in the context of the invention.

Rigidified pins (3) have an elongated thin body capable to pass through the pin holes (16) of inner metal track and the pin holes (13) of attachable tire track and a wide surface disable to pass through the pin holes (13, 16) and resting on the vehicle tire at the lower portion.

Track locking pins (4) are used to join the inner metal tracks (2) together by being passed through the connection tabs (17) of inner metal track and the perforated connection tabs (15) of tire track and also to join the attachable tire tracks (1) together.

Front stretcher hooks (5) are used to join front stretcher rubber (11) and attachable tire tracks (1) together. One end of the front stretcher hook is attached to the stretcher hooks (14) of tire track and the other end is attached to the front stretcher rubber (11).

After the jamming capsules (8) of steel rope are connected to both open ends of the steel rope (9) of rear stretcher, steel rope (9) of rear stretcher is shielded by being placed in the steel rope covering (10) of rear stretcher. Steel rope covering (10) of the rear stretcher is made of flexible plastic material and has a tube or hose shaped structure. Steel rope covering (10) of rear stretcher is used to protect the steel rope (9) of rear stretcher from wear and corrosion. At the same time, steel rope c (10) of rear stretcher prevents wear of vehicle tire (B) due to the friction between the steel rope (9) of rear stretcher and the vehicle tire. Thus, if the steel rope (9) of rear stretcher is used with the absence of the steel rope covering (10) of rear stretcher, both the vehicle tire (B) is damaged and its strength is diminished in time due to corrosion and wear.

User holds two ends of steel ropes (9) of rear stretcher to join these two ends together behind the vehicle tire to surround the axle periphery when the vehicle tire (B) is on the vehicle. In this position, these two ends of the steel rope (9) of rear stretcher are joined together by attaching jamming capsules (8) of steel rope to the lock piece (7) of rear stretcher. In this position, rear stretcher hooks (6) are used to join steel rope (9) of rear stretcher and attachable tire tracks (1) together. One end of the rear stretcher hook (6) is attached to the stretcher hooks (14) of tire track and the other end is attached to the steel rope (9) of rear stretcher.

In FIG. 2, a perspective view of the attachable tire track system (A) and its parts after mounting on the vehicle tire (B) is seen.

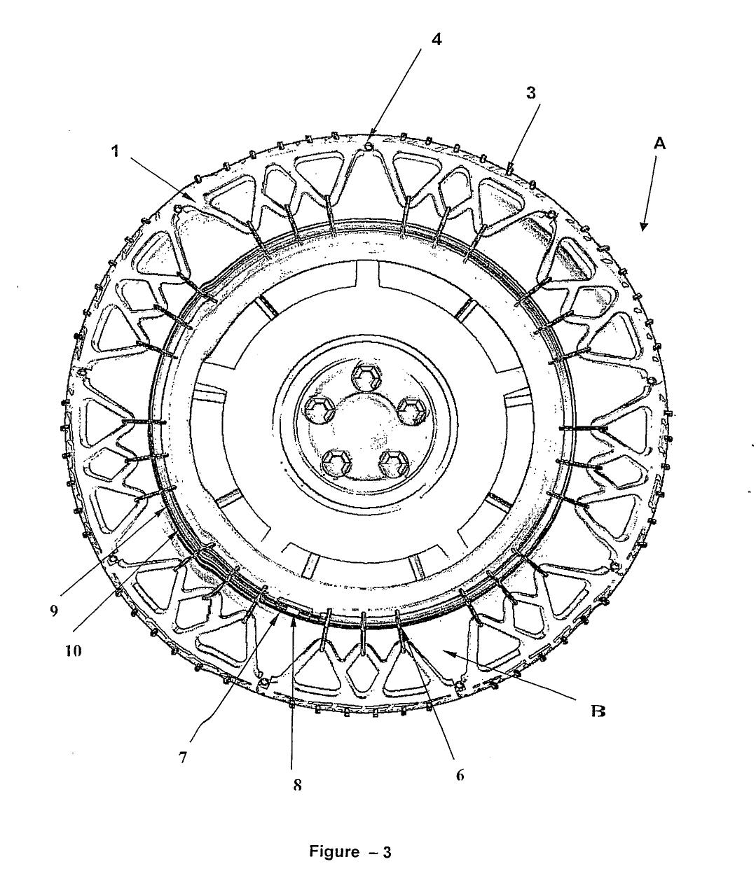

In FIG. 3, a rear view of the attachable tire track system (A) and its parts after mounting on the vehicle tire (B) is seen.

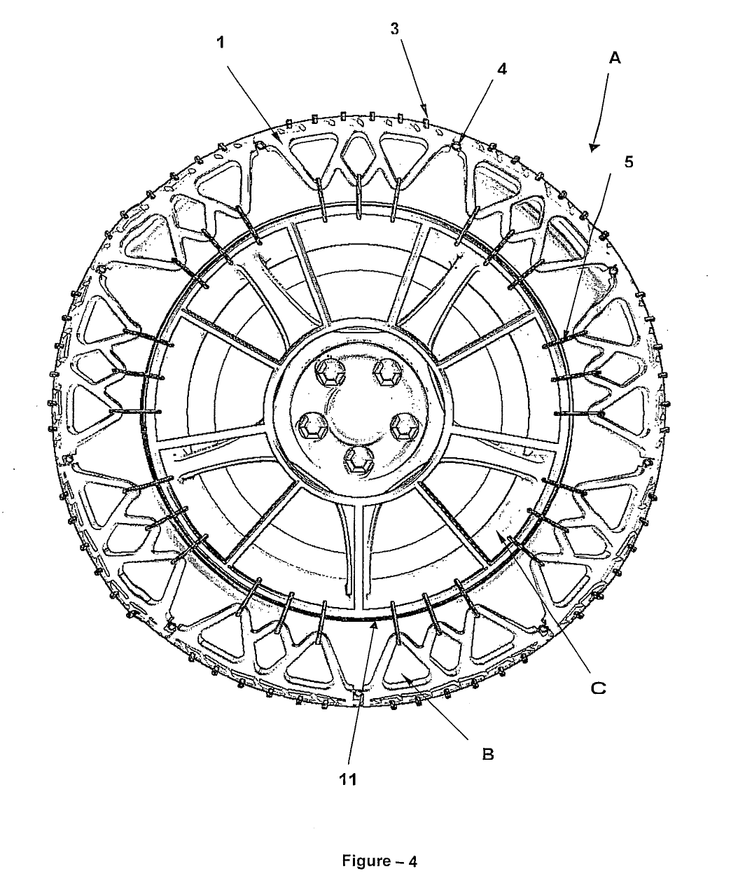

In FIG. 4, a front view of the attachable tire track system (A) and its parts after mounting on the vehicle tire (B) is seen.

In FIGS. 2, 3, 4:
Rigidified pins (3) outwardly extend under the inner metal track (2) and are passed through the pin holes (16) of inner metal track and pin holes (13) of tire track and its wide surfaces rest on the vehicle tire (B).
Joined track structure by rigidified pins (3) constitutes the attachable tire track and inner metal track (2) so that the attachable tire track (1) is at the top and the inner metal track (2) is at the bottom,
Attachable tire tracks (1) joined from the connection tabs (15) of tire track by the track locking pins (4) wraparound the vehicle tire (B).
Behind the vehicle tire (B), jamming capsules (8) of steel rope attached open ends of steel rope (9) of rear stretcher in the steel rope covering (10) of rear stretcher are attached to the lock piece (7) of rear stretcher.
Steel rope (9) of rear stretcher is joined to stretcher ropes (14) of tire track by rear stretcher hooks (6).
In front of the vehicle tire or at the side of rim cover (C), front stretcher hooks are joined to the stretcher ropes (14) of tire track by the front stretcher rubber (11).

Attachable tire track system (A) is on the vehicle tire (B).

As an alternative to the attachable tire track system (A) described above, the connection of the attachable tire tracks (1) and the inner metal tracks (2) could be obtained by producing the inner metal tracks (2) as embedded in the attachable tire tracks (1). In this case, the pin holes (13) of tire track and pin holes (16) of inner metal track are coaxial, connection tabs (17) of inner metal track is embedded in the connection tabs (15) of tire track and holes are coaxial. In this type of integral structure, by only attaching track locking pins (4) to connection tabs (15) of tire track, connection tabs (17) of inner metal track and hence the connection of inner metal tracks are done as well. Therefore, user does not have to make the connection of inner metal tracks (2) in the attachable tire track system (A). Moreover, since the inner metal tracks (2) are embedded in the attachable tire tracks, the possibility of damage by the inner metal tracks (2) to the vehicle tire is avoided. In this case in FIGS. 2, 3, 4:
Rigidified pins (3) outwardly extend under the attachable tire track (1) and are passed through the pin holes (16) of inner metal track and pin holes (13) of tire track and its wide surfaces rest on the vehicle tire (B).
Attachable tire tracks (1) joined from the connection tabs (15) of tire track by the track locking pins (4) wraparound the vehicle tire (B).
Behind the vehicle tire (B), jamming capsules (8) of steel rope attached to two open ends of steel rope (9) of rear stretcher in the steel rope covering (10) of rear stretcher are attached to the lock piece (7) of rear stretcher.
Steel rope (9) of rear stretcher is joined to stretcher ropes (14) of tire track by rear stretcher hooks (6).
In front of the vehicle tire or at the side of rim cover (C), front stretcher (5) are joined to the stretcher ropes (14) of tire track by the front stretcher rubber (11).

An alternative of attachable tire track system (A) is on the vehicle tire (B).

Preferred attachable tire track system (A) above is not intended to limit the protection scope of the invention. In view of the described knowledge by the invention, all modifications on this preferred attachable tire track system (A) should be interpreted in the protection scope of the invention.

1. Attachable tire track system (A); comprising,
band formed attachable tire tracks (1) whose outer surfaces (12) are grooved similar to the patterns of vehicle tires (B), pin holes (13) of tire track through which rigidified pins (3) can be fitted and said tracks (1) which are, wrapped around the vehicle tire (B),
track locking pins (4), front tensioner hooks (5), rear tensioner hooks (6), lock piece (7), tightening capsules (8), a steel rope (9), a steel rope covering (10) and a front tensioner rubber (11),
inner metal tracks (2) provided with hollow connection tabs (17) on two sides of each metal track to connect the inner metal tracks (2) together;
rigidified pins (3) which are being passed through the Pin holes (16) of inner metal track and pin holes (13) of tire track;
characterized in that when the said system (A) is attached to the vehicle tire (B), to improve the strength, avoid tearing, and support the attachable tire track (1), said inner metal tracks (2), which are band formed, being placed between the attachable tire tracks (1) and the vehicle tire (B);
said rigidified pins (3) which outwardly extend under the inner metal track (2) and have a head portion which does not pass through corresponding holes (16) of the tracks (2), and the head portion of said rigidified pins (3) rest on the surface of tire (B), when the system (A) is attached;
said track locking pins (4) which are used to join the inner metal tracks (2) and the attachable tire tracks (1) by being passed through the connection tabs (17) of inner metal track and the hollow connection tabs (15) of tire track;
in the rear side of the vehicle tire (B), tightening capsules (8) attached to both open ends of steel rope (9), which is inside of the steel rope covering (10), being attached to the lock piece (7), and said steel rope (9) being joined to tensioner loops (14) of tire track by rear tensioner hooks (6);
in front of the vehicle tire (B) or at the side of rim cover (C), front tensioner hooks (5) being joined to the tensioner loops (14) of tire track by the front tensioner rubber (11).

2. Attachable tire track system (A) according to claim 1, wherein tensioner loops (14) of tire track are at the opposite two ends of the said track (1) matching to the lateral surfaces of the vehicle tire (B).

3. Attachable tire track system (A) according to claim 1, wherein hollow connection tabs (15) of tire track are at the other two ends of the said track (1)

4. Attachable tire track system (A) according to claim 1, wherein attachable tire tracks (1) are preferably made of rubber material which is more elastic than that of the vehicle tire (B).

5. Attachable tire track system (A) according to claim 1, wherein steel rope (9) is placed, to be protected from wear and corrosion, in the steel rope covering (10) made of flexible plastic material.

6. Attachable tire track system (A) according to claim 1, wherein the inner metal tracks (2) are embedded in the attachable tire tracks (1).

7. Attachable tire track system (A) according to claim 1, wherein connection tabs (17) of inner metal track are embedded in connection tabs (15) of tire track and whose pin holes are coaxial.

8. Attachable tire track system (A) according to claim 6, wherein connection tabs (17) of inner metal track are embedded in connection tabs (15) of tire track and whose pin holes are coaxial.
